(19) United States
(12) Patent Application Publication
(10) Pub. No.: US 2021/0163815 A1
(43) Pub. Date: Jun. 3, 2021

(54) POLYMERS FOR THE ASSISTED RECOVERY OF HYDROCARBONS

(71) Applicant: IFP Energies nouvelles, Rueil-Malmaison Cedex (FR)

(72) Inventors: Bruno DELFORT, RUEIL-MALMAISON CEDEX (FR); Isabelle HENAUT, RUEIL-MALMAISON CEDEX (FR)

(21) Appl. No.: 17/263,069

(22) PCT Filed: Jul. 10, 2019
(86) PCT No.: PCT/EP2019/068622

§ 371 Date: Jan. 25, 2021

(30) Foreign Application Priority Data
Jul. 26, 2018 (FR) 1856972

(51) Int. Cl. C09K 8/588; C08F 220/58

(52) U.S. Cl. CPC C09K 8/588; C08F 220/58

(57) ABSTRACT

The invention relates to a water-soluble polymer, for the enhanced recovery of hydrocarbons, of formula (I)

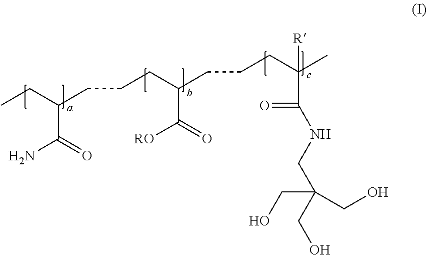

wherein
R is a hydrogen atom or an alkaline metal element
R′ is a hydrogen atom or a methyl radical
the coefficients a, b and c are defined in the following way:
a/(a+b+c) is greater than or equal to 0.50,
b/(a+b+c) is between 0 and 0.50, limits included,
c/(a+b+c) is between 0.001 and 0.20, limits included,
all of the ratios a/(a+b+c), b/(a+b+c) and c/(a+b+c) have a sum equal to 1.

The invention also relates to the process for preparing said polymer, and to the use thereof for enhanced hydrocarbon recovery.

### TECHNICAL FIELD

The present invention relates to the field of exploring for and exploiting a subterranean formation. The invention relates more particularly to the treatment of a fluid recovered from the subterranean formation.

The invention notably relates to the field of enhanced hydrocarbon recovery (EOR, for Enhanced Oil Recovery) and to the field of the treatment of production waters.

### PRIOR ART

For the exploration and exploitation of a subterranean formation, it is common practice to inject a fluid into the subterranean formation in order to increase the efficiency of the processes (Han D. K. & al, Recent Development of Enhanced Oil Recovery in China, J. Petrol. Sci. Eng. 22(1-3): 181-188; 1999). In order to optimize these processes, it is common practice to include at least one additive in the injected fluid. This additive may take the form of a formulation of organic molecules, such as polymers, copolymers and/or surfactants, etc. This formulation may also contain inorganic molecules such as minerals (clays, barite, etc.), oxide particles (titanium oxides, iron oxides, etc.), etc. The addition of additive(s) presents certain problems notably linked to the presence of the additive, or of molecules constituting it, in the water produced.

For enhanced oil recovery in particular, it is advantageous to know whether the additive used, in general polymers, copolymers and surfactants, is in the water produced, in order to carry out an appropriate treatment of the water.

There are several enhanced oil recovery methods. When the injected fluid, also known as sweep fluid, has compounds added to it, the term tertiary enhanced recovery is used. These chemical compounds are polymers, surfactants, alkaline compounds, or mixtures of these compounds. In comparison with a simple injection of water or brine, the advantage of the presence of a polymer is to increase the viscosity of the sweep fluid and consequently to improve the mobility ratio of the injected fluid to the hydrocarbons in place in the subterranean formation.

The hydrocarbon recovery yield is increased by means of a better efficiency of the sweeping of the formation (Han D. K. & al, Recent Development of Enhanced oil Recovery in China, J. Petrol. Sci. Eng. 22(1-3): 181-188; 1999). The polymers used in this method are generally polymers of high molecular masses chosen for their viscosifying properties at moderate concentrations.

During oil production operations, water is frequently co-produced with the crude oil; a ratio of 3 barrels of aqueous effluent per barrel of crude oil is commonly stated.

The crude oil and the water must then be separated. The oil is thus transported to its refining site, and the water is treated so as to remove the unwanted compounds from it and so as to comply with discharge standards.

Various techniques are applied for treating production waters, in particular for removing dispersed drops of crude: sedimentation by gravity separation, centrifugation, flotation with or without injection of gas, and filtration.

The use of polymers in tertiary enhanced recovery nevertheless presents practical problems. At the production wells, a mixture of aqueous fluid and hydrocarbons is recovered in the form of an emulsion, in which the water/hydrocarbon ratio changes depending on the duration of production. The presence of polymer in the production fluid, owing to the viscosifying effect of said polymer, makes it more difficult to separate the various fluids (oil/gas/water) and, in particular, to carry out secondary treatments on the water (Zhang Y. Q & al. Treatment of produced water from polymer flooding in oil production by the combined method of hydrolysis acidification dynamic membrane bioreactor-coagulation process, J. Petrol. Sci. Eng., 74 (1-2): 14-19, 2010). When the production effluent reaches the surface, it is treated in a surface unit. This unit makes it possible to separate the various fluids, namely gas, oil and water. On conclusion of the surface treatment, the hydrocarbons are ready to be refined. The water is treated and decontaminated in order to minimize toxic product discharges into the environment, the thresholds of which are subject to standards. The presence of the polymer in the produced fluids, as is reported in document SPE 65390 (2001) “Emulsification and stabilization of ASP Flooding Produced liquid”, can lead to the stabilization of the emulsions in the produced fluids and can present problems in terms of the surface treatment processes, in terms of the water/oil/gas separation and, in particular, in terms of the secondary water treatment processes.

While the advantage of the presence of a polymer is to increase the viscosity of the sweep water in order to improve the extraction of the hydrocarbons in place in the subterranean formation, the viscosity of the water when it is produced becomes an obstacle to separation between the water and the hydrocarbons.

This problem has led operators in the field to envisage means for reducing the viscosity of the water produced, in order to improve separation between the water and the hydrocarbons. Among these means, the degradation of the viscosifying polymer(s) in the produced water is envisaged and is described in the prior art.

The conventional polymers used for enhanced oil recovery (EOR) are polymers of high molar masses which generally belong to the polyacrylamide (PAM) family or the partially hydrolysed polyacrylamide (HPAM) family. They may optionally contain monomer units of N-vinylpyrrolidone or acrylamido-tert-butyl sulfonate (ATBS) type.

Polyacrylamides are obtained by radical polymerization of acrylamide according to the following general scheme.

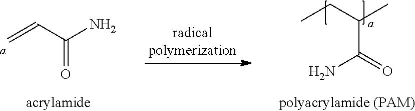

Partially hydrolysed polyacrylamides are copolymers of acrylamide with either acrylic acid or an acrylate, for example an acrylate of an alkali metal element, for instance sodium. They may be represented, for example, by the following general formula in which the alkali metal element is sodium. The acrylamide monomer unit is generally predominant.

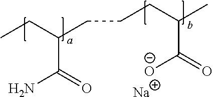

Partially hydrolysed polyacrylamides may be obtained for example by copolymerization of acrylamide with acrylic acid, the carboxylic acid function of which may optionally be neutralized to a carboxylate function of an alkali metal element, for instance sodium. Partially hydrolysed polyacrylamides may also be obtained by copolymerization of acrylamide with an acrylate of an alkali metal element, for instance sodium acrylate. Partially hydrolysed polyacrylamides may also be obtained by polymerization of acrylamide to polyacrylamide, followed by partial hydrolysis of the amide functions to carboxylic acid functions or to carboxylate functions of alkali metal salts.

HPAMs may be random or block copolymers.

FIG. 1 summarizes the routes for synthesis of the partially hydrolysed polyacrylamides of the prior art in the case where the alkali metal element is sodium.

The degradation of these polymers in order to reduce or eliminate their viscosifying effect is notably described in the document SPE-163751 “Chemical degradation of HPAM by oxidization in produced water, (2013)”, in which the HPAMs are degraded by the action of oxidizing agents such as hydrogen peroxide or sodium persulfate, or by photodegradation in the presence of titanium dioxide. The document SPE-169719-MS “Treating back produced polymer to enable use of conventional water treatment technologies (2014)” describes, in order to reduce the viscosity of the produced water, the degradation of HPAM polymers via the action of various oxidizing agents such as potassium persulfate, potassium percarbonate, hydrogen peroxide, sodium hypochlorite, Fenton's reagent or potassium permanganate.

The document SPE-179776-MS “Management of viscosity of the back produced viscosified water, (2016)” describes, in order to reduce the viscosity of the produced water, the degradation of HPAM polymers mechanochemically, thermally and chemically, in particular by means of chlorinated derivatives.

The means appearing in the prior art for degrading the polymer are based essentially on the use of chemical reagents, in particular oxidizing agents (Ahmadum & al; Review of technologies for oil and gas produced water management; J. Hazard Mater., 170(2-3): 530-551. 2009). The efficacy of the treatment depends essentially on the reactivity per se of these oxidizing agents, on their concentration and on the conditions under which the degradation will be carried out, in particular the reaction time and temperature. The operations described, starting from a polymer which is a conventional HPAM, entail optimizing the choice and the concentration of the oxidizing agent and also the reaction conditions.

Certain fluids used in particular as fluids in hydraulic fracturing operations contain other polymers, which can be crosslinked under the action of boron derivatives. This crosslinking enables an increase in the viscosity of the fluid and/or the formation of gels. This increase in viscosity is desirable in order to improve the efficacy of the fluid. U.S. Pat. Nos. 3,800,872, 6,060,436 and 6,642,185 describe the use of such fluids.

The polymers which are known and used for these applications belong generally to the families of vinyl polyalcohols or polysaccharides such as guar gums, hydroxyethylcelluloses, carboxyethyl celluloses and galactomannans. They exhibit the particular feature of containing hydroxyl functions. It is these functions which react with the boron derivatives to form bonds between the chains of polymers and so to increase the viscosity of the solutions containing them.

The boron derivatives used are generally chosen from boric acid, salts of boric acid such as sodium meta borate, sodium tetra borate, and organic borates.

According to this prior art, the viscosity of aqueous solutions containing certain polymers which are not PAMs or HPAMs may be enhanced following a chemical action with certain boron derivatives.

Surprisingly, the viscosity of aqueous solutions containing the polymers of the invention, conversely, is reduced following chemical reaction with certain boron derivatives.

The Applicant has therefore found, surprisingly, that it was possible to inject aqueous fluid containing a particular polymer conforming to the general formula (I) of the invention and enabling an increase in the viscosity of the aqueous fluid so as to adapt it to the viscosity of the oil to be produced.

The Applicant has also found that it was then possible, when the fluid is reproduced at the surface, and following an appropriate chemical treatment, to diminish or eliminate the viscosifying effect of the polymer of the invention, so as to regain a viscosity close to or the same as that which the fluid would have in the absence of this viscosifying polymer.

### DESCRIPTION OF THE INVENTION

### Summary of the Invention

The invention relates to a water-soluble polymer, for the enhanced recovery of hydrocarbons, of formula (I)

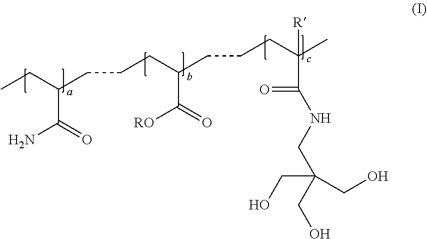

wherein
R is a hydrogen atom or an alkaline metal element
R′ is a hydrogen atom or a methyl radical
the coefficients a, b and c are defined in the following way:
a/(a+b+c) is greater than or equal to 0.50, preferably greater than or equal to 0.60
b/(a+b+c) is between 0 and 0.50, preferably between 0.10 and 0.40, limits included,
c/(a+b+c) is between 0.001 and 0.20, preferably between 0.01 and 0.10, limits included,
all of the ratios a/(a+b+c), b/(a+b+c) and c/(a+b+c) have a sum equal to 1.

The invention also relates to a process for preparing said polymer, wherein the water-soluble polymer according to the invention is prepared by radical polymerization of:

acrylamide,
optionally acrylic acid and/or an alkali metal salt of acrylic acid,
and tris(hydroxymethyl)-N-methylacrylamide and/or tris(hydroxymethyl)-N-methylmethacrylamide.

In one embodiment, it is possible to use acrylic acid and it is possible to carry out a second step of neutralizing the acid to salt using an alkaline base, for example, sodium or potassium hydroxide.

In one embodiment, wherein b=0, the water-soluble polymer according to the invention is prepared by polymerization of acrylamide and tris(hydroxymethyl)-N-methylacrylamide and/or tris(hydroxymethyl)-N-methylmethacrylamide.

Advantageously, the polymerization reaction is conducted in aqueous phase and initiated by one or more radical polymerization initiators such as organic peroxides or hydroperoxides, azo compounds such as 2,2′-azobis(2-methylpropionitrile), ammonium persulfates or alkali metal cation persulfates, at a temperature generally of between 20° C. and 100° C., most generally between ambient temperature and 80° C., preferably under an inert atmosphere, for a period of between 2 minutes and 12 hours.

Said water-soluble polymer is advantageously isolated at the end of the polymerization reaction, for example, by precipitation from an anti-solvent chosen preferably from organic solvents known to those skilled in the art, especially acetone or methanol, to give a precipitated polymer.

The invention also relates to a process for enhanced hydrocarbon recovery in a subterranean formation, in particular of crude oil, comprising at least the following steps:
a) at least one fluid is injected into said subterranean formation, said injected fluid comprising at least one water-soluble polymer in aqueous solution, of formula (I)

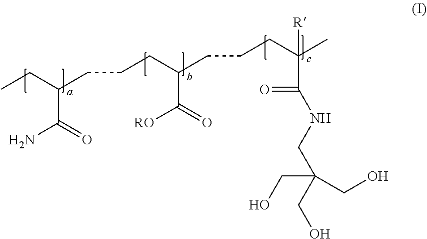

wherein
R is a hydrogen atom or an alkaline metal element
R′ is a hydrogen atom or a methyl radical
the coefficients a, b and c are defined in the following way:
a/(a+b+c) is greater than or equal to 0.50, preferably greater than or equal to 0.60
b/(a+b+c) is between 0 and 0.50, preferably between 0.10 and 0.40, limits included,
c/(a+b+c) is between 0.001 and 0.20, preferably between 0.01 and 0.10, limits included,
all of the ratios a/(a+b+c), b/(a+b+c) and c/(a+b+c) have a sum equal to 1;
b) at least one production effluent is recovered from said subterranean formation, comprising at least one aqueous phase and one organic phase.

The process may comprise a step c) in which the effluent comprising the water-soluble polymer is treated with at least one boron-derived reagent in order to reduce the viscosity of the aqueous phase of said production effluent so as to enable the separation and/or the subsequent treatment of said aqueous phase treated with said boron-derived reagent.

Advantageously, the boron-derived reagent is chosen from alkaline metal or alkaline-earth metal or ammonium polyborates, boric acid, or the alkaline metal or alkaline-earth metal or ammonium salts of boric acid.

The boron-derived reagent is preferably chosen from sodium tetraborate Na₂B₄O₇, disodium octaborate Na₂B₈O₁₃, 4H₂O, ammonium pentaborate (NH₄)B₅O₈, preferably sodium tetraborate Na₂B₄O₂.

The process can comprise a step d) of separating the aqueous phase and the organic phase of said production effluent.

Steps c) and d) can be reversed and/or repeated.

Said aqueous phase of the production effluent, containing said polymer treated with said boron-derived reagent, may be contacted with an acid so as to regain its initial viscosity.

The invention lastly concerns the use of a water-soluble polymer as an additive to the injected fluid in a process for enhanced hydrocarbon recovery in a subterranean formation, in particular of crude oil, said water-soluble polymer being of formula (I):

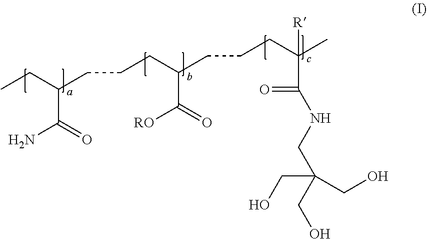

wherein:
R is a hydrogen atom or an alkaline metal element
R′ is a hydrogen atom or a methyl radical
the coefficients a, b and c are defined in the following way:
a/(a+b+c) is greater than or equal to 0.50, preferably greater than or equal to 0.60
b/(a+b+c) is between 0 and 0.50, preferably between 0.10 and 0.40, limits included,
c/(a+b+c) is between 0.001 and 0.20, preferably between 0.01 and 0.10, limits included,
all of the ratios a/(a+b+c), b/(a+b+c) and c/(a+b+c) have a sum equal to 1.

### LIST OF FIGURES

FIG. 1 presents the scheme of the routes for synthesis of partially hydrolysed polyacrylamides of the prior art.

FIG. 2 presents the chemical formula (I) of the polymers according to the invention.

FIG. 3 presents the synthesis scheme for the polymers according to the invention. FIG. 3A represents the synthesis scheme for the polymer according to the invention when b is other than 0,

FIG. 3B represents the synthesis scheme for the polymer according to the invention, without acrylic acid or salt of acrylic acid, when b is 0.

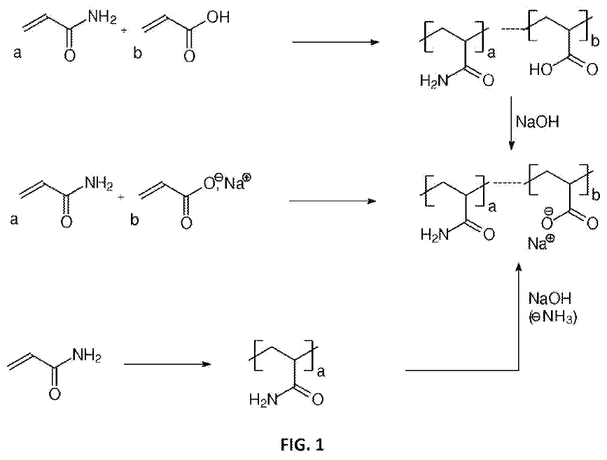

The figures illustrate the invention in a non-limiting manner.

### DETAILED DESCRIPTION OF THE INVENTION

The present invention relates to the synthesis and use of a family of polymers that is particularly suitable on the one hand, having the effect of increasing the viscosity of the sweep fluid when incorporated into this fluid, and, on the other hand, no longer having this effect under the action of an appropriate chemical reagent when the aim is to regain a lower viscosity.

The particular viscosified polymers conforming to the general formula (I) belong to the general family of polyacrylamides or of partially hydrolyzed polyacrylamides, but differ therefrom in the presence, within the polymer chain, of particular units which endow them with the particular properties described.

The polymers of the invention conform to the following general formula (I)

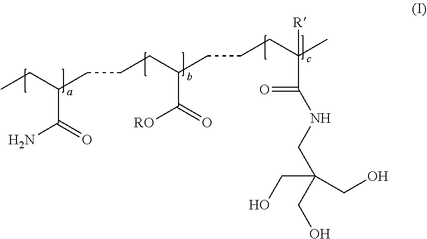

wherein:
R is a hydrogen atom or an alkaline metal element
R′ is a hydrogen atom or a methyl radical.
The coefficients a, b and c are defined in the following manner:
a/(a+b+c) is greater than or equal to 0.50, preferably greater than or equal to 0.60
b/(a+b+c) is between 0 and 0.50, preferably between 0.10 and 0.40, limits included,
c/(a+b+c) is between 0.001 and 0.20, preferably between 0.001 and 0.10, limits included,
all of the ratios a/(a+b+c), b/(a+b+c) and c/(a+b+c) have a sum equal to 1.

It is notably apparent that aqueous solutions containing the polymers of the invention exhibit modified viscosities when they are treated with certain reagents derived from boron, and especially lower viscosities when they are treated with certain reagents derived from boron.

Furthermore, the aqueous solutions containing the polymers of the invention and having been treated with certain reagents derived from boron are able to regain their initial viscosity when they are treated subsequently by contact with an acid—for example, without limitation, an acid chosen from acetic acid, hydrochloric acid, sulfuric acid and phosphoric acid.

It is therefore possible to use the polymers of the invention as an additive in EOR fluids, enabling:
on the one hand an increase in the viscosity of the fluid so as to optimize the enhanced recovery of hydrocarbons
and on the other hand a reduction in the viscosity of the fluid once it has been reproduced at the surface, so as to promote separation of the hydrocarbons from the water.

When these fluids have been reproduced, indeed, it becomes possible to lower their viscosity by treating them with certain boron-derived reagents, in order to promote separation of the oil from the aqueous phase.

The boron derivatives are chosen, for example, from borates, especially alkali metal or alkaline-earth metal or ammonium polyborates, such as sodium tetraborate Na₂B₄O₇, disodium octaborate Na₂B₈O₁₃, 4H₂O, ammonium pentaborate (NH₄)B₅O₈ or boric acid, or one of its alkali metal or alkaline-earth metal or ammonium salts.

### Preparation of the Polymers According to the Invention

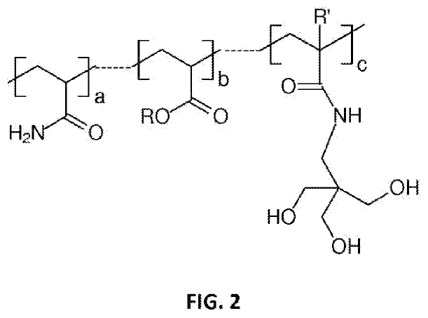

The general formula (I) of FIG. 2 illustrates the structure of the polymers according to the invention, with the monomer providing the hydroxyl functions being tris(hydroxymethyl)-N-methylacrylamide and/or tris(hydroxymethyl)-N-methylmethacrylamide.

The polymers of the invention may be random or sequenced.

The polymers of the invention may therefore be synthesized by radical polymerization of:
acrylamide,
optionally acrylic acid and/or an alkaline metal salt of acrylic acid
and tris(hydroxymethyl)-N-methylacrylamide and/or tris(hydroxymethyl)-N-methylmethacrylamide.

When acrylic acid is used in place of an alkali metal salt of acrylic acid, it is possible, in a second step, to neutralize the acid salt using an alkaline base, for example, sodium or potassium hydroxide.

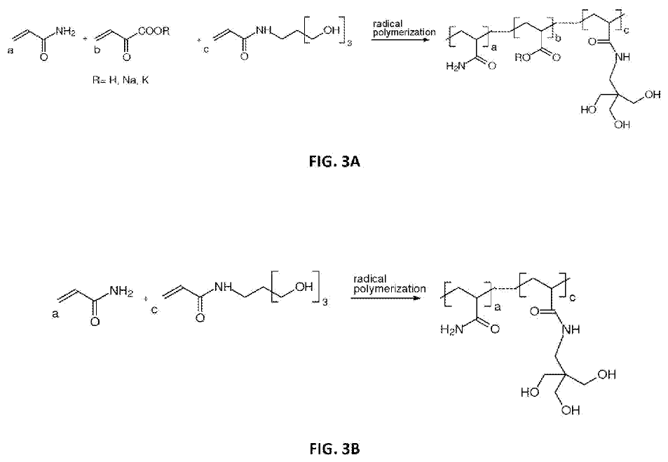

In a first embodiment, described in FIG. 3A, the polymer according to the invention is synthesized by radical polymerization of acrylamide, acrylic acid and/or a sodium or potassium salt of acrylic acid, and tris(hydroxymethyl)-N-methylacrylamide and/or tris(hydroxymethyl)-N-methylmethacrylamide (in FIG. 3A, tris(hydroxymethyl)-N-methylacrylamide is used).

In a second embodiment, described in FIG. 3B, when in the general formula b/(a+b+c)=zero and therefore b=zero, the synthesis reaction is a polymerization of acrylamide and tris(hydroxymethyl)-N-methylacrylamide and/or tris(hydroxymethyl)-N-methylmethacrylamide (in FIG. 3B, tris(hydroxymethyl)-N-methylacrylamide is used).

### Operating Conditions

### Polymerization

The polymerization reactions are conducted generally in water. The reactions are initiated by one or more radical polymerization initiators belonging to well-known chemical families, such as, for example, organic peroxides or hydroperoxides, azo compounds such as 2,2′-azobis(2-methylpropionitrile), ammonium persulfates or alkali metal cation persulfates.

The polymerization reactions are carried out at a temperature generally of between 20° C. and 100° C., most generally between ambient temperature and 80° C.

The polymerization reactions are preferably carried out under an inert atmosphere.

The polymerization time is generally between a few minutes and a few hours, preferably between 2 minutes and 12 hours, preferably between 1 and 6 hours, very preferably between 1 and 5 hours, limits included.

The monomers are preferably dissolved in an aqueous solution, in the proportions which make it possible to obtain the desired ratios between the indices a, b and c. The solution may be degassed beforehand using an inert gas such as nitrogen or argon, so as to obtain an inert atmosphere. The polymerization initiator chosen is then introduced in proportions known to those skilled in the art for initiating polymerization. The mixture is optionally heated so as to obtain a temperature above ambient temperature, and is optionally subjected to stirring. The mixture is advantageously cooled to ambient temperature. The polymer obtained is then isolated, advantageously by precipitation from an anti-solvent. The polymer is advantageously washed, preferably with the same anti-solvent, then advantageously dried at a temperature of between 20° C. and 100° C. for a period of between 1 to 24 h. The polymer may optionally be used at the end of the polymerization step, without applying a precipitation step. In that case, the reaction solution containing the polymer may optionally be concentrated by partial removal of the solvent.

### Enhanced Hydrocarbon Recovery Process According to the Invention

The invention also relates to the use of the water-soluble polymer of formula (I) as an additive to the injected fluid in a process for enhanced hydrocarbon recovery in a subterranean formation, in particular of crude oil.

More specifically, the invention relates to a process for enhanced hydrocarbon recovery in a subterranean formation, in particular of crude oil, comprising at least the injection of at least one fluid into said subterranean formation, where said injected fluid comprises at least said water-soluble polymer in aqueous solution, of formula (I), and the recovery of at least one production effluent from said subterranean formation. The effluent advantageously comprises at least one aqueous phase and one organic phase.

Following the injection of at least one fluid into the subterranean formation in accordance with the process according to the invention, when the production effluent is recovered at the surface, the separation of the production water and the polymer may be facilitated by a chemical treatment which makes it possible to lower the viscosity of the water-soluble polymer described above.

In a context of enhanced oil recovery (EOR), when the production water containing the polymer of the invention is reproduced, the reaction which enables a reduction in the viscosifying effect of the polymer of the invention may advantageously be brought about by the action of a boron derivative, especially:
an alkali metal or alkaline-earth metal or ammonium polyborate, especially sodium tetraborate Na₂B₄O₇,
or boric acid or an alkali metal or alkaline-earth metal or ammonium salt thereof.

This reaction generally takes place at ambient temperature and its effect is considered to be immediate after mixing.

At the end of this reaction, it may be advantageous, in light of the drop in viscosity, to separate the water and oil phases.

Said aqueous phase of the production effluent, containing said polymer treated with said boron-derived reagent, may optionally be contacted subsequently with an acid so as to regain its initial viscosity.

### EXAMPLES

### Example 1: Synthesis of Polymer According to the Invention

The polymer is prepared according to the synthesis scheme of FIG. 3B.

30 mg of ammonium persulfate are introduced into a solution of 7.1 g (0.1 mol) of acrylamide and 44.3 mg (2.5 10⁻⁴ mol) of tris(hydroxymethyl)-N-methylacrylamide in 150 g of water, previously degassed with argon, and then the medium is brought to 60° C. with stirring for 5 hours. After a return to ambient temperature, the polymer formed is isolated by precipitation from 1 liter of acetone. After washing with 250 ml of acetone, the polymer is dried at 50° C. for 5 hours. 6.85 g of an off-white solid are obtained.

The polymer obtained has the formula (I) with a=0.998, b=0, c=0.002, R′=H.

The polymer is dissolved in water to give 50 g of a solution of this polymer at each of the concentrations 0.8%, 1.6% and 2.3% by mass.

For each concentration of polymer, 25 g of solution as reference and 25 g of solution in which 20 mg of sodium tetraborate are dissolved are taken. The samples are stored under an argon atmosphere before use.

A viscosity measurement is carried out on each sample, using a rotational rheometer (DHR3 from TA Instruments). A double cylinder-type geometry is used. A logarithmic flow sweep is carried out at between 1 and 200 s⁻¹. The values are measured at 10 s⁻¹.

Table 1 below enables a comparison of the viscosities obtained from the same solution of the polymer of the invention before (V1) and after addition of sodium tetraborate (V2), for various concentrations of polymer in water. It is clearly apparent that the viscosifying power of the polymer of the invention at each of the concentrations studied is affected by treatment with sodium tetraborate. The V2/V1 ratio illustrates the sensitivity of the reduction in viscosity.

TABLE 1
Variation in viscosity of a polymer according to the invention
by treatment with sodium tetraborate as a function of the
concentration of the polymer in water in % by mass.

| | |
|---|---|
| Concentration | Viscosity (Cp) |

| of the polymer | | After treatment | |
|---|---|---|---|
| in water | Reference | with tetraborate | |
| (% by mass) | V1 | V2 | V2/V1 |
| 0.8 | 6.5 | 4.6 | 0.71 |
| 1.6 | 16.0 | 12.0 | 0.75 |
| 2.3 | 63.0 | 23.0 | 0.37 |

### Example 2: Synthesis of a Polymer According to the Invention

The polymer is prepared according to the synthesis scheme of FIG. 3B.

60 mg of ammonium persulfate are introduced into a solution of 7.1 g (0.1 mol) of acrylamide and 88.5 mg (5.0 10⁻⁴ mol) of tris(hydroxymethyl)-N-methylacrylamide in 150 g of water, previously degassed with argon, and then the medium is brought to 60° C. with stirring for 5 hours. After a return to ambient temperature, the polymer formed is isolated by precipitation from 1 liter of acetone. After washing with 250 ml of acetone, the polymer is dried at 50° C. for 5 hours. 6.60 g of an off-white solid are obtained.

The polymer obtained has the formula (I) with a=0.995, b=0, c=0.005, R′=H.

The polymer is dissolved in water to give 50 g of a solution of this polymer at each of the concentrations 0.8%, 1.6% and 2.3%, 3.0% and 4.5% by mass.

For each concentration of polymer, 25 g of solution as reference and 25 g of solution in which 20 mg of sodium tetraborate are dissolved are taken. The samples are stored under an argon atmosphere before use.

A viscosity measurement is carried out on each sample, using a rotational rheometer (DHR3 from TA Instruments). A double cylinder-type geometry is used. A logarithmic flow sweep is carried out at between 1 and 200 s⁻¹. The values are measured at 10 s⁻¹.

Table 2 below enables a comparison of the viscosities obtained from the same solution of the polymer of the invention before (V1) and after addition of sodium tetraborate (V2), for various concentrations of polymer in water. It is clearly apparent that the viscosifying power of the polymer of the invention at each of the concentrations studied is affected by treatment with sodium tetraborate. The V2/V1 ratio illustrates the sensitivity of the reduction in viscosity.

TABLE 2
Variation in viscosity of a polymer according to the invention
by treatment with sodium tetraborate as a function of the
concentration of the polymer in water in % by mass.

| | |
|---|---|
| Concentration | Viscosity (Cp) |

| of the polymer | | After treatment | |
|---|---|---|---|
| in water | Reference | with tetraborate | |
| (% by mass) | V1 | V2 | V2/V1 |
| 0.8 | 3.9 | 2.9 | 0.74 |
| 1.6 | 30.0 | 7.3 | 0.24 |
| 2.3 | 35.8 | 10.0 | 0.28 |
| 3.0 | 313.0 | 19.3 | 0.06 |
| 4.5 | 1935.0 | 61.0 | 0.03 |

### Example 3: Synthesis of a Polymer According to the Invention

The polymer is prepared according to the synthesis scheme of FIG. 3B.

120 mg of ammonium persulfate are introduced into a solution of 7.1 g (0.1 mol) of acrylamide and 310.1 mg (1.8 10⁻³ mol) of tris(hydroxymethyl)-N-methylacrylamide in 150 g of water, previously degassed with argon, and then the medium is brought to 60° C. with stirring for 5 hours. After a return to ambient temperature, the polymer formed is isolated by precipitation from 1 liter of acetone.

After washing with 250 ml of acetone, the polymer is dried at 50° C. for 5 hours. 6.3 g of an off-white solid are obtained.

The polymer obtained has the formula (I) with a=0.982, b=0, c=0.018, R′=H.

The polymer is dissolved in water to give 50 g of a solution of this polymer at each of the concentrations 0.8% and 1.6% by mass.

For each concentration of polymer, 25 g of solution as reference and 25 g of solution in which 20 mg of sodium tetraborate are dissolved are taken. The samples are stored under an argon atmosphere before use.

A viscosity measurement is carried out on each sample, using a rotational rheometer (DHR3 from TA Instruments). A double cylinder-type geometry is used. A logarithmic flow sweep is carried out at between 1 and 200 s⁻¹. The values are measured at 10 s⁻¹.

The table below enables a comparison of the viscosities obtained from the same solution of the polymer of the invention before (V1) and after addition of sodium tetraborate (V2), for various concentrations of polymer in water. It is clearly apparent that the viscosifying power of the polymer of the invention at each of the concentrations studied is affected by treatment with sodium tetraborate. The V2/V1 ratio illustrates the sensitivity of the reduction in viscosity.

TABLE 3
Variation in viscosity of a polymer according to the invention
by treatment with sodium tetraborate as a function of the
concentration of the polymer in water in % by mass.

| | |
|---|---|
| Concentration | Viscosity (Cp) |

| of the polymer | | After treatment | |
|---|---|---|---|
| in water | Reference | with tetraborate | |
| (% by mass) | V1 | V2 | V2/V1 |
| 0.8 | 4.0 | 2.8 | 0.70 |
| 1.6 | 7.8 | 4.9 | 0.63 |
| 2.8 | 77.5 | 26.3 | 0.34 |

### Example 4 (Comparative): Synthesis of a Polyacrylamide

60 mg of ammonium persulfate are introduced into a solution of 10.0 g (0.14 mol) of acrylamide in 250 g of water, previously degassed with argon, then the medium is brought to 60° C. with stirring for 5 hours. After a return to ambient temperature, the polymer formed is isolated by precipitation from 1.8 liters of acetone. After washing with 500 ml of acetone, the polymer is dried at 50° C. for 5 hours. 9.1 g of an off-white solid are obtained.

The polymer is dissolved in water to give 50 g of a solution of this polymer at each of the concentrations 0.8%, 1.6% and 2.3% by mass.

For each concentration of polymer, 25 g of solution as reference and 25 g of solution in which 20 mg of sodium tetraborate are dissolved are taken. The samples are stored under an argon atmosphere before use.

A viscosity measurement is carried out on each sample, using a rotational rheometer (DHR3 from TA Instruments). A double cylinder-type geometry is used. A logarithmic flow sweep is carried out at between 1 and 200 s⁻¹. The values are measured at 10 s⁻¹.

The table below enables a comparison of the viscosities obtained from the same solution of this polymer before (V1) and after addition of sodium tetraborate (V2), for various concentrations of polymer in water. It is clearly apparent that the viscosifying power of the polyacrylamide at each of the concentrations is increased by treatment with sodium tetraborate. The V2/V1 ratio illustrates the sensitivity of this increase in the viscosity.

TABLE 4
Variation in viscosity of a polyacrylamide by treatment
with sodium tetraborate as a function of the concentration
of the polyacrylamide in water in % by mass.

| | |
|---|---|
| Concentration | Viscosity (Cp) |

| of the polymer | | After treatment | |
|---|---|---|---|
| in water | Reference | with tetraborate | |
| (% by mass) | V1 | V2 | V2/V1 |
| 0.8 | 3.3 | 4.5 | 1.36 |
| 1.6 | 12.0 | 16.0 | 1.33 |
| 2.3 | 27.0 | 41.0 | 1.52 |

### Example 5 (Comparative): Synthesis of a Poly(Acrylamide-Co-Sodium Acrylate)

27 mg of ammonium persulfate are introduced into a solution of 4.2 g (0.059 mol) of acrylamide and 0.80 g (0.0085 mol) of sodium acrylate in 260 g of water, previously degassed with argon, then the medium is brought to 60° C. with stirring for 5 hours. After a return to ambient temperature, the polymer formed is isolated by precipitation from 1.4 liter of acetone. After washing with 500 ml of acetone, the polymer is dried at 50° C. for 5 hours. 3.1 g of an off-white solid are obtained.

The polymer is dissolved in water to give 50 g of a solution of this polymer at the concentration of 1.4% by mass.

25 g of solution as reference and 25 g of solution in which 20 mg of sodium tetraborate are dissolved are taken. The samples are stored under an argon atmosphere before use.

A viscosity measurement is carried out on each sample, using a rotational rheometer (DHR3 from TA Instruments). A double cylinder-type geometry is used. A logarithmic flow sweep is carried out at between 1 and 200 s⁻¹. The values are measured at 10 s⁻¹.

The table below enables a comparison of the viscosities obtained from the same solution of the polymer of the invention before (V1) and after addition of sodium tetraborate (V2), for various concentrations of polymer in water. It is clearly apparent that the viscosifying power of the polymer of the invention at each of the concentrations studied is affected by treatment with sodium tetraborate. The V2/V1 ratio illustrates the sensitivity of the reduction in viscosity.

TABLE 5
Variation in viscosity of a poly(acrylamide-co-sodium acrylate) by
treatment with sodium tetraborate as a function of the concentration
of the poly(acrylamide-co-sodium acrylate) in water, in % by mass

| | |
|---|---|
| Concentration | Viscosity (Cp) |

| of the polymer | | After treatment | |
|---|---|---|---|
| in water | Reference | with tetraborate | |
| (% by mass) | V1 | V2 | V2/V1 |
| 1.4 | 27.0 | 24.8 | 0.91 |

It is apparent that the aqueous solutions containing the polymers according to the invention (examples 1 to 3) exhibit reduced viscosities when they are treated with sodium tetraborate, and do so throughout the range of concentrations studied.

As a comparison, the aqueous solutions containing a polyacrylamide (example 4, comparative) exhibit increased viscosities when they are treated with sodium tetraborate, and do so throughout the range of concentrations studied.

As a comparison, when it is treated with sodium tetraborate, the comparative aqueous solution containing a poly(acrylamide-co-sodium acrylate) (example 5, comparative) exhibits a reduced viscosity, but significantly less reduced than the aqueous solutions containing the polymers of the invention. These behaviors are illustrated by an examination of the ratios V2/V1 in tables 1 to 3 (effect of the treatment on the viscosity of the polymers according to the invention) and in tables 4 and 5 (effect of the treatment on the viscosity of the prior-art polymers).

1. A water-soluble polymer for enhanced hydrocarbon recovery, of formula (I) 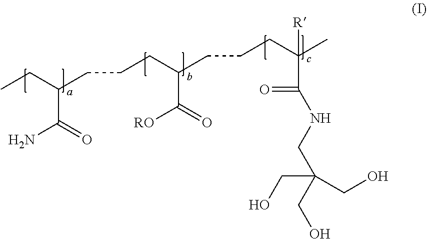
wherein
R is a hydrogen atom or an alkaline metal element
R′ is a hydrogen atom or a methyl radical
the coefficients a, b and c are defined in the following way:
a/(a+b+c) is greater than or equal to 0.50, preferably greater than or equal to 0.60
b/(a+b+c) is between 0 and 0.50, preferably between 0.10 and 0.40, limits included,
c/(a+b+c) is between 0.001 and 0.20, preferably between 0.01 and 0.10, limits included,
all of the ratios a/(a+b+c), b/(a+b+c) and c/(a+b+c) have a sum equal to 1.

2. A process for preparing a polymer as claimed in claim 1, wherein the water-soluble polymer is prepared by radical polymerization of:
acrylamide,
optionally acrylic acid and/or an alkaline metal salt of acrylic acid
and tris(hydroxymethyl)-N-methylacrylamide and/or tris(hydroxymethyl)-N-methylmethacrylamide.

3. The preparation process as claimed in claim 2, wherein acrylic acid is used and a second step is carried out, of neutralizing the acid to a salt using an alkali metal base, for example, sodium or potassium hydroxide.

4. The process for preparing a water-soluble polymer as claimed in claim 2, wherein b=0 and the water-soluble polymer is prepared by polymerization of acrylamide and tris(hydroxymethyl)-N-methylacrylamide and/or tris(hydroxymethyl)-N-methylmethacrylamide.

5. The preparation process as claimed in claim 2, wherein the polymerization reaction is conducted in aqueous phase and initiated by one or more radical polymerization initiators such as organic peroxides or hydroperoxides, azo compounds such as 2,2′-azobis(2-methylpropionitrile), ammonium persulfates or alkali metal cation persulfates, at a temperature generally of between 20° C. and 100° C., most generally between ambient temperature and 80° C., preferably under an inert atmosphere, for a period of between 2 minutes and 12 hours.

6. The preparation process as claimed in claim 2, wherein the water-soluble polymer is isolated at the end of the polymerization reaction, for example, by precipitation from an anti-solvent chosen preferably from organic solvents known to those skilled in the art, especially acetone or methanol, to give a precipitated polymer.

7. A process for enhanced hydrocarbon recovery in a subterranean formation, in particular of crude oil, comprising at least the following steps:
a) at least one fluid is injected into the subterranean formation, the injected fluid comprising at least one water-soluble polymer in aqueous solution, of formula (I) 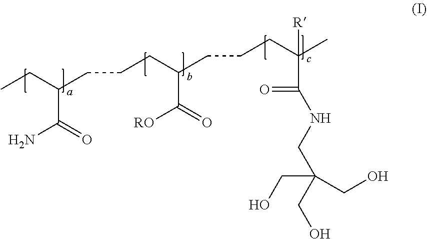
wherein
R is a hydrogen atom or an alkaline metal element
R′ is a hydrogen atom or a methyl radical
the coefficients a, b and c are defined in the following way:
a/(a+b+c) is greater than or equal to 0.50, preferably greater than or equal to 0.60
b/(a+b+c) is between 0 and 0.50, preferably between 0.10 and 0.40, limits included,
c/(a+b+c) is between 0.001 and 0.20, preferably between 0.01 and 0.10, limits included,
all of the ratios a/(a+b+c), b/(a+b+c) and c/(a+b+c) have a sum equal to 1;
b) at least one production effluent is recovered from the subterranean formation, comprising at least one aqueous phase and one organic phase.

8. The process for enhanced hydrocarbon recovery as claimed in claim 7, comprising a step c) in which the effluent comprising the water-soluble polymer is treated with at least one boron-derived reagent in order to reduce the viscosity of the aqueous phase of the production effluent so as to enable the separation and/or the subsequent treatment of the aqueous phase treated with the boron-derived reagent.

9. The process for enhanced hydrocarbon recovery as claimed in claim 8, wherein the boron-derived reagent is chosen from alkali metal or alkaline-earth metal or ammonium polyborates, boric acid, or alkali metal or alkaline-earth metal or ammonium salts of boric acid.

10. The process for enhanced hydrocarbon recovery as claimed in claim 9, wherein the boron-derived reagent is chosen from sodium tetraborate Na₂B₄O₇, disodium octaborate Na₂B₈O₁₃, 4H₂O, ammonium pentaborate (NH₄)B₅O₈, preferably sodium tetraborate Na₂B₄O₇.

11. The process of enhanced hydrocarbon recovery as claimed in claim 7, comprising a step d) of separating the aqueous phase and the organic phase of the production effluent.

12. The process for enhanced hydrocarbon recovery as claimed in claim 7, wherein steps c) and d) are reversed and/or repeated.

13. The process for enhanced hydrocarbon recovery as claimed in claim 8, wherein the aqueous phase of the production effluent, containing the polymer treated with the boron-derived reagent, is contacted with an acid to regain its initial viscosity.

14. The use of a water-soluble polymer as an additive to the injected fluid in a process for enhanced hydrocarbon recovery in a subterranean formation, in particular of crude oil, the water-soluble polymer being of formula (I): 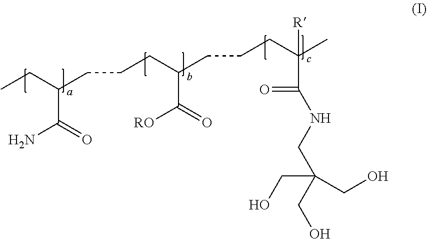
wherein:
R is a hydrogen atom or an alkaline metal element
R′ is a hydrogen atom or a methyl radical
the coefficients a, b and c are defined in the following way:
a/(a+b+c) is greater than or equal to 0.50, preferably greater than or equal to 0.60
b/(a+b+c) is between 0 and 0.50, preferably between 0.10 and 0.40, limits included,
c/(a+b+c) is between 0.001 and 0.20, preferably between 0.01 and 0.10, limits included,
all of the ratios a/(a+b+c), b/(a+b+c) and c/(a+b+c) have a sum equal to 1.
